(19) United States
(12) Patent Application Publication
(10) Pub. No.: US 2005/0234743 A1
(43) Pub. Date: Oct. 20, 2005

(54) Medical examination or treatment device

(75) Inventor: Birgit Dusch, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 11/085,925

(22) Filed: Mar. 22, 2005

(30) Foreign Application Priority Data
Mar. 31, 2004 (DE) 10 2004 015 857.6

(51) Int. Cl. G06F 17/60

(52) U.S. Cl. 705/2

(57) ABSTRACT

Medical examination and/or treatment apparatus (1, 3), designed to perform various patient-related machine activities, specifically image acquisition and/or analysis and/or storage, as part of a patient examination and/or treatment or subsequent processing and/or documentation of examination and/or treatment information, said apparatus (1, 3) being designed to automatically record the start and end of an activity chargeable to a third party in respect of the costs on the basis of trigger signals indicating the start and end of said activity and received by a device (5) for determining the start and end of machine activities, to automatically determine, after recorded completion of the activity, the activity-specific costs using machine activity related cost information stored in a storage device (7), and to display the costs on a monitor (4).

### CROSS REFERENCE TO RELATED APPLICATIONS

This application claims priority to the German application No. 10 2004 015 857.6, filed Mar. 31, 2004 which is incorporated by reference herein in its entirety.

### FIELD OF INVENTION

The invention relates to a medical examination and/or treatment apparatus implemented to carry out various patient-related machine activities, particularly of image acquisition and/or analysis and/or storage, in the context of patient examination and/or treatment or subsequent processing and/or documentation of examination and/or treatment information.

### BACKGROUND OF INVENTION

Different implementations of examination and/or treatment apparatus of the abovementioned type are well-known, including, for example, magnetic resonance, computer tomography, x-ray or ultrasound machines. All are used for imaging an object under examination in the context of patient examination and/or treatment. The images obtained can be analyzed to automatically determine particular items of image data; they can be stored e.g. also on separate removable storage media or the like. Depending on the type of apparatus and its design, a more or less large number of different machine activities can be performed as part of the examination or treatment or subsequent processing or documentation.

In order to be able to utilize such an apparatus as efficiently as possible, maximum cost transparency is advantageous in order to record which calculable costs, i.e. costs that can be passed on to the patient, are incurred within the scope of an examination/treatment, also in relation to the duration of said examination/treatment. Cost recording is generally carried out quasi manually by the physician or medical technician logging which cost-relevant activities have been performed in order to subsequently determine the examination or treatment costs on the basis of this record. This is laborious and ultimately error-prone and does not lead to adequate cost transparency either for the patient or for the attending physician or the operator of the equipment. It is in the very context of “increasing healthcare efficiency” that this cost transparency is absolutely necessary for the operator in order to identify savings potentials.

Publication DE 101 18 747 A1 discloses a method for comparing a usage of a device from a set of devices of a comparable type, there being provided automatic creation of individual usage statistics of the device, for which purpose times during which the device constituting a unit or a technical system is being used or is occupied or activated are recorded. Similarly, publication DE 101 28 261 A1 relates to a method for economic assessment of a device wherein details of times when the device is being used are recorded as data for describing the designated usage of the device.

A medical treatment apparatus for carrying out dental examinations or treatments is known from publication DE 298 22 219 U1, wherein the treatment apparatus is operated via a user interface and possibly a voice input unit. There is additionally provided a link to an administration computer to which work carried out by the dentist and which has been dictated via a microphone is transmitted. Treatment and cost plans can also be filled in by “drag and drop” functions. Publication DE 36 12 158 A1 relates to a medical accounting machine which automatically calculates medical costs, wherein different details such as the medical department or type of insurance are entered via input devices. Details of the treatment are likewise entered and registered. Registered contents are in turn stored and totaled.

### SUMMARY OF INVENTION

An object of the invention is therefore to specify an apparatus of the abovementioned type which enables at least part of the examination- or treatment-related costs to be recorded in a simple manner.

To solve this problem it is inventively provided for an apparatus of the abovementioned type that it is designed to automatically record the start and end of an activity chargeable to a third party in respect of the cost on the basis of trigger signals which indicate the start and end of the activity and which are received by a device for determining the start and end of machine activities, to automatically determine, on recorded completion of the activity, the activity-specific costs on the basis of machine activity cost information stored in a storage device, and to display the costs on a monitor.

The apparatus according to the invention is capable of recording a completely executed i.e. unaborted machine activity and to process the recording instant virtually as the triggering moment for determining the activity-related costs. Automatic activity recording allows direct cost recording, thereby making it possible for corresponding cost information to be made immediately available to both the patient and the physician or operator, in order to continuously display to him the machine activity related costs accruing in the context of the ongoing examination/treatment. Corresponding cost information concerning the different machine activities that can be carried out on the part of the apparatus are stored in a suitable storage device. A machine activity is recorded on the basis of corresponding trigger signals which indicate the start and end of the activity. In the case of a magnetic resonance system, for example, the start of an image acquisition measurement, for example, constitutes the initiating trigger event for a cost-relevant “imaging” activity, the completion of acquisition constitutes virtually the final trigger moment on the basis of which it is detected on the apparatus side that imaging has been terminated in an orderly manner, i.e. has not been aborted. As soon as this information is present, the corresponding cost entry is read out of the storage means and displayed to the user or patient.

As stated, the machine activities can be any activities carried out automatically on the part of the apparatus. These will primarily be activities relating to imaging, as the central characteristic of the system in question is the acquisition of different kinds of images of an area under examination. These can be snapshots, e.g. in the context of magnetic resonance or computer tomography examinations, but also continuous image-based monitoring such as, for example, in an x-ray system by means of which e.g. the movement of a catheter can be monitored under x-ray control, the system being itself able to record the type or quality of the machine activity being carried out by it, i.e. it can detect by itself which activity it is now specifically performing, on the basis of which the corresponding activity-specific costs are then determined.

In order to allow maximally complete recording of chargeable activities and a resulting maximally complete recording of the accruing costs, the apparatus is designed according to the invention to record a plurality of simultaneously or consecutively executed activities and to determine the several activity-specific costs as well as to cumulatively display the unit costs and/or to display total cost details. This means that any number of different machine activities are recorded as and when they are carried out, so that continuous cost recording and display is possible. The individual activities and the associated activity-specific costs are displayed both individually and cumulatively, so that the physician or patient can see which specific machine activity has been performed and recorded and the nature of the individual activity costs. Alternatively or additionally it is also possible to calculate continuously adapted total cost information which naturally changes with each additional action.

According to a particularly useful further development of the invention it can be provided that the device is designed to record costs for regularly performed non-machine activities relating to a machine activity, in particular activities carried out manually by an attendant when the associated machine activity is being recorded, and to display said costs. This is based on the knowledge that, for various machine activities, certain non-machine activities are either absolutely necessary or very likely to be required e.g. on the part of the physician in advance of, during or after performance of the machine activity. Such activities include the necessary administration of particular medicines required for a particular machine activity, i.e. a certain type of imaging or the like. Also conceivable is the administration of one or more doses of contrast medium, the positioning on the patient of certain examination or treatment means required for imaging, possibly moving the patient in order to position him correctly for a particular type of examination, etc. For a machine activity with which such quasi mandatory parallel actions are associated, the apparatus is now able, according to the invention, to automatically record the corresponding action- or activity-specific costs in addition to the activity costs of the recorded or identified machine activity, and does so after completion of the executed machine activity, i.e. when it is certain that the latter has actually been carried out.

Generally, but particularly in this connection it is expedient for the apparatus, when recording a machine activity, to be designed to provide information about other activities of a machine or non-machine type to be carried out simultaneously and/or subsequently, and to specify the activity-specific costs in the manner of a menu display. Said menu display provides the physician with a kind of “checklist” of any other activities of a machine and/or non-machine type and their specific costs so that he can check, on the one hand, whether the corresponding actions have been carried out, be they of the machine type and must therefore be performed by the apparatus itself, be they of the non-machine type and must therefore be performed e.g. by him, and which actions are still to be performed. The accruing costs for the recorded and any future machine activity are only taken into account when, in response to the corresponding trigger signals, the actual performance and the non-aborted completion of a machine activity is recorded. In so far as actions to be performed of necessity are involved, from which it is assumed that they took place in any event, non-machine costs are automatically calculated, preferably if it is established that the preceding machine activity is complete. A calculation is also conceivable if the start of an associated machine activity was recorded but the activity was aborted, the non-machine activities still having taken place, even though imaging, for example, was aborted for whatever reason.

It is useful for non-machine activities specified in the menu display to be user-selectable, the apparatus being designed for cost recording on a selection-dependent basis. According to this inventive embodiment, the costs of the non-machine activities associated with a completed machine activity consequently are not necessarily taken into account; rather it is incumbent upon the physician to select which non-machine activity actually was or is being carried out and is therefore chargeable. This expediently takes place in the menu display, all information of any kind relating to the activities or the costs being of course displayed to the physician on a suitable monitor or the like.

In the context of activity selection, two different selection mechanisms are conceivable. According to a first inventive alternative, all non-machine activities can be checkmarked as carried out in the menu display, a non-machine activity that was not carried out or is not to be performed being deselected by the user. This means that basically all associated non-machine activities are costed in, and the physician has to actively determine the activities which were not carried out or are not being carried out and must not therefore be taken into account. Alternatively, the procedure can operate vice versa, i.e. all non-machine activities are checkmarked as not carried out, but are only listed and must be actively user-selected as a non-machine activity that has been carried out or is to be carried out. This means that the physician specifies what has been done or is to be done, only the activities actively selected by him being costed in. Selection is expediently performed within the menu display on the monitor using normal input means such as a mouse and cursor.

A further useful development of the inventive idea additionally provides that the apparatus, particularly in connection with the menu display, is designed to display, depending on selection, other user-selectable information about consumables which were used or are being used as part of a machine or non-machine activity and to detail the specific costs as well as to record costs. This enables the physician, particularly in the context of the menu display which offers him cost transparency in respect of the prescribed activities, to select further information which is relevant from a costing standpoint. This could include, for example, consumables such as dressings and bandages, paper for lining the patient positioning table, any special clothing for the patient, ear plugs, etc. Once again the physician is usefully provided with a suitable list of selectable consumables, either automatically if a particular machine action has been recorded, or at his instigation if he wishes to enter corresponding information.

It is further conceivable for the apparatus, particularly in connection with the menu display, to be embodied to display, depending on the selection, other user-selectable information concerning examination- or treatment-relevant actions and also to detail the specific costs as well as to record costs. Thus, should other relevant actions which are in any way cost-relevant be capable of being performed depending on the nature of the apparatus, said actions are likewise displayed automatically via the apparatus and can be selected by the user.

It must be noted in this connection that the apparatus, whatever form it takes, naturally has a suitable computer device in addition to the storage device in which are stored, on the one hand, all the relevant activities of whatever kind as well as other information of whatever kind as described above as displayable. Via said computer device, the start and end of the corresponding machine activity is recorded and the screen information and costs, etc. to be displayed are selected. The computer is also able to forward relevant information within a network.

Finally it can be provided that the apparatus is designed to record, specifically in connection with the menu display, user-inputtable information about activities performed on a non-machine basis, consumables or other examination- and/or treatment-related actions, as well as to record, process and display information-specific costs which are stored on the apparatus side or which can be input by the user. According to this inventive embodiment it is therefore additionally possible for the physician to enter specific information which is in any way cost-related. In this connection possible changes to options proposed by the apparatus can also be made. For example, if the administration of a dose of contrast medium is indicated and costed as a non-machine activity necessarily associated with a machine activity, it is possible for the physician according to this embodiment of the invention to specify that he has administered, for example, two or three doses of contrast medium. The corresponding information, which constitutes an information change, is then costed in accordingly. In this way the physician can also, for example, enter any actions preceding the examination/treatment, such as holding consultations or preparatory discussions, etc.

### BRIEF DESCRIPTION OF THE DRAWINGS

Further advantages, features and details of the invention will emerge from the example described below and with reference to the accompanying drawings in which:

FIG. 1 shows a schematic diagram of the medical examination and/or treatment apparatus according to the invention,

FIG. 2 shows a flowchart representing a possible cost determination sequence, and

FIG. 3 shows a schematic representation of a screenshot after cost determination.

### DETAILED DESCRIPTION OF INVENTION

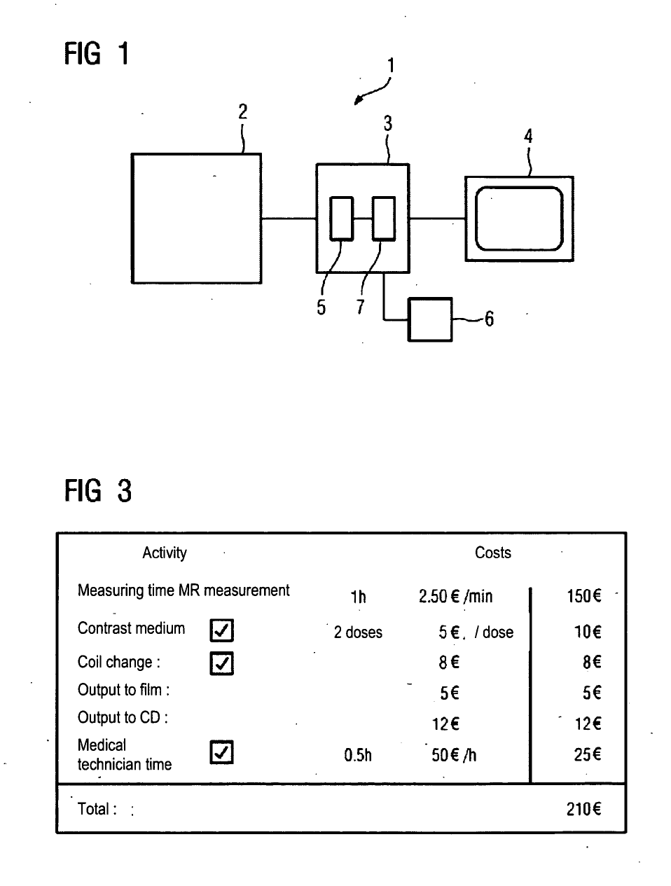

FIG. 1 shows an inventive medical examination and/or treatment apparatus 1 which can be of any kind, conceivably a magnetic resonance, computer tomography, x-ray or ultrasound system. An apparatus of this kind basically comprises an examination section 2 which is used for imaging and implemented according to the design of the system. It can be, for example, an examination section of a magnetic resonance system, an x-ray radiator and receiver of an x-ray machine, etc. There is additionally provided a computing device 3 which is typically used to control the entire operation of the apparatus 1, but in the case of the inventive apparatus 1 is also used to determine cost-related activities and to display corresponding determination and cost results on a monitor 4 on which e.g. an acquired examination image is also displayed. For this purpose the computing device 3 has a device 5 for determining the start and end of machine activities as part of the examination or treatment or of image data processing or documentation of the image data, which machine activities can be performed via the examination section 2 or e.g. an image memory and/or image output device 6 assigned to the computing device 3. There is additionally provided a storage device 7 in which more detailed information about the automatically recordable machine activities and non-machine actives as well as information relating to consumables or other treatment- or examination-related information is stored. This data is additionally assigned corresponding data concerning the specific costs in each case, i.e. a corresponding cost record is stored for each machine-performable action, corresponding cost entries are present for every consumable used, etc. The computing device 3 is now able to determine the corresponding costs for machine-recorded activities and to determine, collate and display on the monitor 4 the corresponding costs for corresponding non-machine activities performed or consumables or the like.

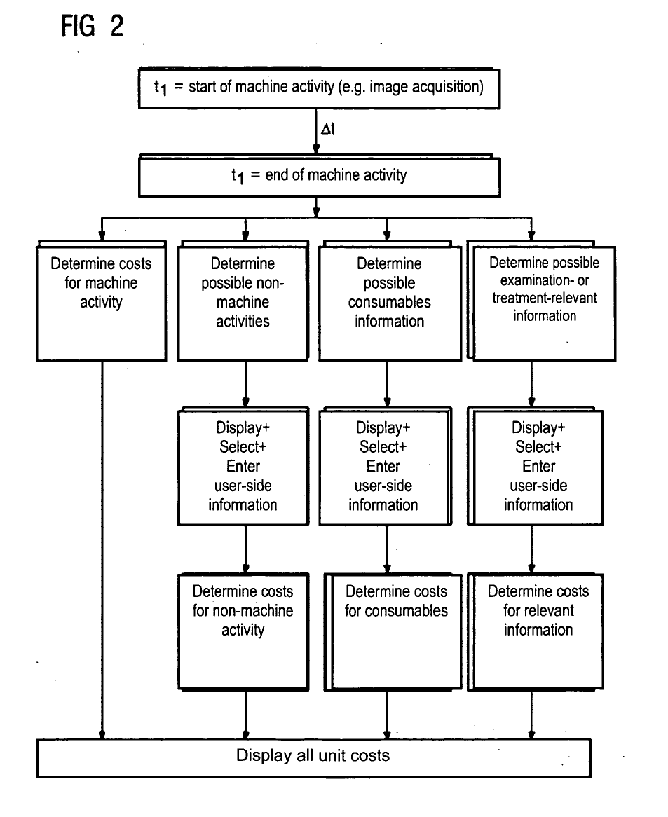

FIG. 2 schematically illustrates the sequence for determining any individual costs in the context of imaging e.g. using a magnetic resonance system.

The machine activity, i.e. image acquisition, for example, begins at instant t₁. The starting instant is the trigger instant for the device 5 which now continuously checks when the initiated imaging is complete. This is the case at instant t₂ after a time period Δt has elapsed. The device 5 receives the corresponding trigger signal that imaging has been completed.

There now follow a number of determination activities on the part of the computing device 3 to acquire various items of data from the storage device 7. On the one hand the computing device 3 has identified which machine activity was carried out, i.e. it has automatically detected that imaging was performed using particular operating or setting parameters. First the costs for this completed machine activity are now read out of the storage device 7.

Simultaneously with this, possible non-machine activities are determined which, for example, were likewise performed or are shortly to be performed of necessity or with a high degree of probability in connection with the machine activity carried out. These non-machine activities can be of any kind and are generally performed by the physician or medical technician. They include, for example, the administration of medicines and other agents necessary for imaging, or the administration of contrast medium or the like.

These possible non-machine activities determined are then displayed on the monitor 4. The physician can now select on the monitor 4 which of the displayed non-machine activities he has now actually performed. It may be the case, however, that one or other activity qualified by the system as probably carried out was not performed, this being selected accordingly by the physician. In this step the physician can also enter corresponding user information concerning indicated activities. If, for example, he has administered two doses of contrast medium instead of the single dose indicated by the apparatus, this is entered accordingly, for which purpose the physician can use the menu displayed to him on the monitor 4 and containing all the output information. The physician therefore enters e.g. in the “contrast medium” field that he has administered two doses. He can also select other activities here, such as a possible coil change which he performed prior to imaging if the recorded imaging generally so requires. Once the physician has performed the selection and completely entered any input information, the computing device 3 determines the costs for the individual non-machine activities.

Simultaneously with or subsequent to displaying non-machine activities, on the part of the computing device 3 any consumables information which may be relevant to the machine activity performed is read out of the storage device 7 and displayed. Once again user selection takes place to indicate which consumables have now actually been used, which selection is likewise made within the menu display. After completion of this step also, or even simultaneously, the consumables-specific unit costs are determined.

Finally, any information relating to examination- or treatment-relevant activities are displayed to the physician likewise simultaneously or subsequently after prior selection from the storage device 7. This information can be e.g. personnel-specific information such as the length of time that a medical technician was operative in connection with the machine activity performed.

After all the individual cost items have been determined, they are displayed to the patient or treating physician in menu form on the monitor 4. If now, for example, another machine activity is performed, e.g. outputting of the recorded image to a transportable storage medium such as a CD or DVD, the start and end trigger point for this machine activity is recorded once again on the part of the device 5, whereupon, after the type of machine activity has been identified, the specific activity costs, i.e. in this case the costs for storage and outputting of the image data to the CD, are once again determined from the storage device 7 and added to the activities already displayed.

FIG. 3 is a schematic representation of a screenshot detailing various machine, non-machine and other actions/activities, their unit costs and the overall costs.

The duration of the MR, i.e. magnetic resonance, measurement is the first item under the “Activity” heading. This amounted to one hour. Under the “Costs” heading it is now stated that the measurements costs are EUR 2.50 per minute. The total costs for the measurement performed (i.e. image acquisition) are therefore EUR 150.00.

The next activity item is “Contrast medium”. This is a non-machine activity which, however, in view of the automatically recorded nature of the MR measurement performed, has in all probability been carried out. Adjacent to the activity is a menu field which can be selected by the physician, e.g. via the monitor cursor, if he has actually administered a contrast medium, i.e. he can actively checkmark this activity as cost-relevant. This is represented by the tick in the box. However, the physician has now administered not one but two doses of contrast medium. He can enter this in the menu field to the right via a suitable keyboard or the like. The information “2 doses” is specified here. The cost entry EUR 5.00/dose now appears under the “Costs” heading, giving a total amount of EUR 10.00 for contrast medium administration.

The next activity item is “Coil change”. The nature of the MR measurement suggests that a particular coil had to be used. The physician has also performed this activity as a non-machine activity and indicated accordingly by ticking the box. The coil change costs are EUR 8.00 as specified under the “Costs” heading.

In addition, outputting of the recorded MR image both to a film and a CD took place as another machine activity which was automatically recorded. The relevant costs are EUR 5.00 for film output and EUR 12.00 for CD output. These machine activities, like the MR measurement, were recorded automatically, there being no selection option here.

The final item under the “Activity” heading is “Time MTA”. This is examination- or treatment-related information which can be selected by the physician and indeed was selected in the example shown, as indicated by the tick. In the adjacent field the physician has entered that the medical technician (MTA) was active for 0.5 hours during imaging and the thereby completed examination. This information has also been entered by the physician on the screen. Under the “Costs” heading an hourly rate of EUR 50.00 is now specified for the MTA activity, giving a cost component of EUR 25.00 for the half hour of work.

Finally the accumulated total costs for all the activities performed in this example are specified, i.e. EUR 210.00.

Instead of the costs being determined after completion of a machine activity, as shown in FIG. 2, it is also conceivable for the costs to be determined continuously before the end of a machine activity, i.e. cost-intensive activities or information which are output e.g. continuously or only after detected completion of the machine activity are recorded at an earlier stage.

Obviously FIGS. 2 and 3 only constitute examples and are not to be taken in any limiting sense. Any number of other activities, actions or items of information that are in any way cost-related can of course be recorded or entered. This necessarily depends on the type of apparatus used and the activities performed.

1-9. (canceled)

10. A medical examination or treatment device for executing a machine-based medical examination or treatment procedure including a plurality of machine activities, comprising:
a recording device for detecting and storing a start and an end of at least one of the machine activities using start and end trigger signals representing the start respectively the end of the at least one machine activity;
a database for storing financial cost information related to the plurality of machine activities;
a processing device for calculating financial costs related to the at least one machine activity using the database; and
a screen device for displaying the calculated financial costs, wherein the processing device is configured to calculate the financial costs subsequent to the end of the at least one machine activity using the end trigger signal for initiating the calculating of the financial costs.

11. The device according to claim 10, wherein the examination or treatment procedure includes a procedure taken from the group consisting of recording a medical image of a patient, analyzing a medical image of a patient, storing a medical image of a patient, and processing of examination- or treatment-related data.

12. The device according to claim 10, wherein the device is an apparatus taken from the group consisting of an x-ray device, a computer tomography device, a magnetic resonance device, an ultrasound device and a catheter device.

13. The device according to claim 10, wherein the machine activities include a plurality of simultaneously or subsequently executed machine activities, and the processing device is configured to calculate individual financial costs related to each machine activity and cumulative financial costs related to the plurality of simultaneously or subsequently executed machine activities.

14. The device according to claim 13, wherein the individual costs are displayed on the screen device.

15. The device according to claim 13, wherein the cumulative costs are displayed on the screen device.

16. The device according to claim 10, wherein the processing device is configured to calculate further financial costs related to at least one manual activity associated with the medical examination or treatment procedure, the manual activity executed by an operator of the device during the executing of the medical examination or treatment procedure.

17. The device according to claim 16, wherein the further financial costs are displayed on the screen.

18. The device according to claim 10, further comprising a menu display unit for displaying suggested further activities associated with the at least one machine activity, the suggested further activities including machine activities and manual activities to be executed in parallel or subsequent to the at least one machine activity.

19. The device according to claim 18, wherein the processing device is configured to calculate financial costs related to the suggested further activities.

20. The device according to claim 19, wherein the financial costs related to the suggested further activities are included in the menu display.

21. The device according to claim 18, wherein the menu display includes an input device for selecting at least one of the manual activities, and the processing device is configured to calculate financial costs related to the selected manual activity.

22. The device according to claim 21, wherein all manual activities are marked as selected in the menu display as a default selection, and at least one of the marked manual activities can be dropped by selecting the at least one marked manual activity.

23. The device according to claim 21, wherein all manual activities are marked as non-selected in the menu display as a default selection, and at least one of the non-selected manual activities can be selected using the input device.

24. The medical device according to claim 21, wherein:
the menu display includes information related to expandable items involved in executing the medical examination or treatment procedure,
the input device is configured to select the information, and
the processing device is configured to calculate the financial costs associated with the expandable items.

25. The device according to claim 21, further comprising a data input device for acquiring a data input by a device operator.

26. The device according to claim 25, wherein the data input includes information related to expandable items involved in executing the selected manual activity, and the financial costs related to the selected manual activity include financial costs associated with the expandable items.

27. The device according to claim 26, wherein the database includes all cost information necessary for the processing device to calculate the financial costs related to the at least one machine activity, the financial costs related to the selected manual activity and the financial costs associated with the expandable items.

28. The device according to claim 26, wherein the data input includes the financial costs related to the selected manual activity.

29. The device according to claim 26, wherein the data input includes the financial costs associated with the expandable items.
